(19) United States
(12) Patent Application Publication
(10) Pub. No.: US 2009/0185490 A1
(43) Pub. Date: Jul. 23, 2009

(54) Method of monitoring traffic in an optical or electronic network with shared resources

(76) Inventor: Emmanuel Dotaro, Verrieres Le Buisson (FR)

Correspondence Address: PATTI , HEWITT & AREZINA LLC, ONE NORTH LASALLE STREET, 44TH FLOOR, CHICAGO, IL, 60602, US

(21) Appl. No.: 10/527,335

(22) PCT Filed: Sep. 19, 2003
(86) PCT No.: PCT/FR03/02757

§ 371 Date: Mar. 10, 2005

(30) Foreign Application Priority Data
Sep. 19, 2002 (FR) 02 11 599

(51) Int. Cl. H04J 3/14; H04B 10/08

(52) U.S. Cl. 370/238; 398/25

(57) ABSTRACT

The present invention concerns a method of monitoring traffic in a network in which a plurality of nodes 2A, 2B, 2C, 2D access a common resource 3 such as a wavelength in an optical network. It consists in, in each node: detecting if said resource is being used to send data or if it is not being used for long enough to send a data packet and then, if it is not being used for long enough to send a data packet, prohibiting the node (2B) concerned from sending data in a portion of said resource (3) that is determined statistically as a function of the requirements for use of said resource by all of the nodes (2C, 2D) on the downstream side of the node (2B) concerned.

The present invention relates to a method of monitoring traffic in a network in which nodes access the same resource, which has a linear structure, to send data to other nodes.

A dual bus optical ring network (DBORN) is one example of the above kind of network and transports optical packets. The architecture of this network comprises two rings connected to a concentrator and includes a plurality of nodes such as optical packet add/drop multiplexers, each node being in communication with the concentrator via both rings, and each ring being unidirectional. A plurality of nodes share the same resource, such as a wavelength, for sending packets of data in the direction of the concentrator. Each of the nodes sharing the same resource must use a “gap detection” mechanism to detect absence of transmission of data during a time period at least equal to a fixed time period. When a node has detected a gap, it may send to the resource a packet of data having a duration less than or equal to the fixed duration with no risk of collision with the data sent from a node that precedes it on the bus concerned, referred to as the upstream node. If the resource is a wavelength, a gap is detected using a photodiode adapted to receive only that wavelength. An optical delay line is inserted on the downstream side, between this photodiode and the point from which the data is sent, and determines the maximum time for which the node concerned can send data in each of the gaps. Each packet that a node has to send is stored in a buffer in that node and is sent to the resource only if the photodiode detects a gap of sufficient duration.

However, a network of the above kind based on the sharing of resources gives rise to problems of equity between the nodes; in fact, the more upstream nodes have better access to and use of the bandwidth than the more downstream nodes, since they detect gaps and use them in advance of the more downstream nodes.

A token ring traffic monitoring method known in the art circulates in the ring a token that constitutes an exclusive right to send data: there is only ever one token in the ring at any time. A node that captures the token becomes the only node able to send data to the resource. The token is reset by a director node when the node that has captured it releases it. This method prevents collisions, but does not provide for equitable treatment of upstream and downstream nodes. Moreover, it is not compatible with high bit rates. In fact, sending and returning a token lead to a high transmission delay.

Other prior art methods called deterministic methods divide the sending time into time slots. Each node is entitled to send in a particular time slot. This deterministic subdivision assures each of the nodes a minimum bandwidth.

One example of a deterministic method is described in the document by SHEU P-R et al.: “An optimal time slot assignment algorithm for CRMA high speed networks”, COMPUTER COMMUNICATIONS, ELSEVIER SCIENCE PUBLISHERS BV, AMSTERDAM, NL, vol. 21, N^{o} 7, 15 Jun. 1998, (1998-06-15), pages 675-685, XP004132236, ISSN: 0140-3664. A cyclic reservation multiple access (CRMA) network includes a dual connection, in which one connection is used in a given direction and the other connection is used in the opposite direction. A head node sends frames corresponding to time slots of fixed duration. Those frames essentially transport data from one node to another, each frame being assigned to a single node. The head node periodically sends a special reservation request collection frame. This frame passes through all of the nodes in succession up to an end node and then returns through all of the nodes to the head node. During its return, it records the requirements of all of the nodes in terms of a number of frames. Thus each node reserves a certain number of empty frames for the data that it has to send. The head node then sends a superframe including empty frames assigned to respective requesting nodes. If there are not too many reservations, the superframe includes a number of frames corresponding to the sum of the numbers of frames reserved for all the nodes. If there are too many reservations, to maintain equitable treatment of the nodes, the head node allocates frames in accordance with an appropriate algorithm.

Another example of a deterministic method is described in the book by ANDREW TANENBAUM “Computer networks”, 1996, PRENTICE HALL, UPPER SADDLE RIVER, XP 002243185, which describes a distributed queue dual bus (DQDB). This network includes a dual connection, in which one connection is used in a given direction and the other connection is used in the opposite direction. A head node sends frames corresponding to time slots of fixed duration. Those frames are used essentially to transport data from one node to another, each frame being assigned to a single node. The nodes send their respective data in these frames in accordance with a first-come-first-served discipline, with no centralized queue. To avoid favoring the most upstream stations, for a given direction, each node that wishes to send data in the given direction first makes a reservation by setting to 1 a request bit in a frame on the bus dedicated to the opposite direction. Each node includes a request counter and a downcounter. The request counter counts the number of stations on the downstream side (in the given direction) that have made a reservation by counting returning frames in the upstream direction having a request bit at 1, until this node itself has a packet of data to send, at which point it transfers the content of its request counter into a downcounter and resets its request counter to 0. The request counter then again counts returning frames in the upstream direction having a request bit at 1. The downcounter indicates the number of empty frames that the node concerned must leave available to nodes on the downstream side. Its content is decremented each time that the node registers the passage of a free frame. When the counter reaches zero again, this means that all of the requests from downstream nodes have been satisfied. The node concerned may then use the next empty frame to send data.

The above deterministic methods give rise to certain difficulties. In fact, the use of clearly defined time slots imposes the presence of a synchronization clock in each node in order to synchronize the sending of data in those time slots.

The present invention aims to provide a method of monitoring traffic enabling management of access to a shared resource in a manner that ensures equitable treatment of the nodes without using messages sent via a director node and free of synchronization problems and problems arising from bad use of the bandwidth.

To this end the present invention proposes a method of monitoring traffic in a network comprising a plurality of nodes sharing one or more common resources and having a linear structure for sending data in a given direction, characterized in that it consists in, in each node:
detecting if said resource is being used to send data or if it is not being used;
then, if it is not being used, prohibiting the node concerned from sending data in a portion of said resource that is determined statistically as a function of the requirements for use of said resource by all of the nodes on the downstream side of the node concerned.

The above method ensures equitable access because, in applying it in each node, it preserves a portion of the resource for all of the nodes downstream of the node concerned. Recurrently, the preserved portion increases as a function of how far upstream the node is situated; in other words, the size of the preserved portion increases in direct proportion to the upstream distance to the node concerned. This increase in the size of the preserved portion favors all the downstream nodes to compensate the disadvantage of their downstream position and therefore restores equity. The relevant portion of the resource being determined statistically, preservation is statistical rather than a matter of preservation and assigning a particular portion of the resource to a particular node. It is therefore unnecessary for the resource to be divided into time slots allocated in a fixed manner. Consequently, it is unnecessary to synchronize the operation of the nodes. This method is also compatible with synchronous functioning of the nodes, however.

Note also that it is always feasible to preserve a portion of the resource in all the nodes, regardless of their position. In fact, because the resource portion that is to be preserved is determined as a function of the sum of the requirements of the nodes downstream of the node concerned, the size of this portion decreases as the downstream distance to the node increases, and this portion is a subset of the portion already preserved by the immediately upstream node.

In one particular embodiment, to determine a portion of said resource to be preserved by a statistical process and as a function of the requirements for use of that resource by all of the nodes on the downstream side of the node concerned, the method consists in supplying to each of said nodes statistical information defining the resource requirements of all of the nodes on the downstream side.

Because the information defining the resource requirements for all the downstream nodes is statistical information, a portion of the resource is preserved statistically for those nodes. The portion preserved is not assigned and distributed to each node deterministically, and it is therefore unnecessary to synchronize the operation of the nodes. Another object of the present invention is a network node for implementing the method of the invention.

Other features and advantages of the present invention will become apparent in the course of the following description of one embodiment of the invention given by way of illustrative and non-limiting example.

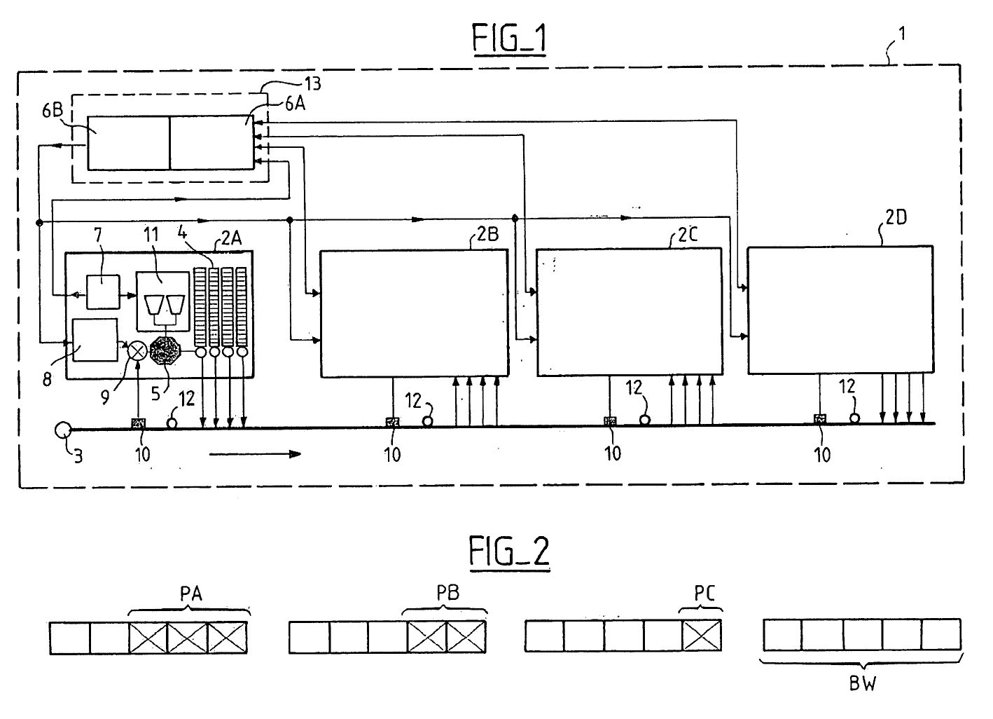

FIG. 1 represents one example of a network using the method of the invention.

FIG. 2 is a diagram of the resource portion preserved by each of the nodes represented in FIG. 1, to illustrate the use of the method of the invention in this network example.

The network 1 represented in FIG. 1 by way of example comprises:
nodes 2A, 2B, 2C, 2D having analogous structures;
a resource 3, which in this example is a wavelength of a dense wavelength division multiplex (DWDM) optical connection, on which all the nodes 2A, . . . , 2D may send using the time-division multiplex technique; and
a bandwidth manager 13 comprising receiving means 6A for receiving and centralizing statistical information on the requirements of the nodes 2A, . . . , 2D and sending means 6B for supplying to each of the nodes 2A, . . . , 2D statistical information on the requirements for use of the resource 3 of the nodes on its downstream side.

In this embodiment, the bandwidth manager is situated in a central entity, which may be any of the nodes of the network, and is connected to all of the nodes of the network 1 by means of the resource 3. This occupies very little of the resource 3, since it is necessary to transmit only a few signaling data packets each time that the statistical requirements of one or more nodes are modified. Such modifications occur only at the time of a change of service agreement.

In other embodiments, the information may be transmitted via any connection, independent of the resource 3.

The propagation direction on the resource 3 corresponds to the order 2A, 2B, 2C, 2D.

All the nodes of the network 1 are similar and each is associated on the resource 3 with a photodiode 10 and an optical delay line 12 on the downstream side of the photodiode 10. Each node sends over the resource 3 on the downstream side of the associated delay line 12. Thus each node is able to detect and use a gap having a duration corresponding to the delay produced by the delay line. The delay is made at least equal to the maximum duration of the packets to be sent. A node begins to send a packet at the start of a gap only if the packet is smaller than the gap that has been detected. Otherwise, the packet remains in the buffer of the node until a sufficiently large gap is detected.

Consider the node 2A by way of example. It comprises:
buffers 4 for storing packets of data to be sent coupled to the resource 3 on the downstream side of the delay line 12 by conventional optical senders and couplers;
a memory 7 for storing the requirements of use of the resource 3 by the node 2A concerned, this memory 7 having an output coupled to the receiver means 6A of the bandwidth manager 13;
a token bucket traffic admission controller 11 having an input connected to an output of the memory 7 and an output supplying a series of sending authorizations each relating to one packet of data;
a memory 8 for storing the requirements of use of the resource 3 by all of the nodes on the downstream side of the node 2A concerned, this memory 8 having a data input coupled to the sending means 6B of the bandwidth manager 13;
a logic circuit 9 having a first input connected to an output of the memory 8, a second input connected to the photodiode 10 and an output; and
a logic circuit 5 having a first input connected to the output of the controller 11, a second input connected to the output of the circuit 9 and an output connected to a read control input of the buffers 4.

FIG. 2 is a diagram of the portion of the resource preserved by each of the nodes represented in FIG. 1, to illustrate the use of the method of the invention in this network example. It represents the respective portion of the resource that each of the nodes 2A, . . . , 2D preserves by refraining from sending data. In this very simple example, each of the nodes statistically requires one fifth of the total bandwidth BW of the resource 3. The most downstream node 2D never refrains from sending when it has detected a gap of sufficient length since there is no node on its downstream side. The next upstream node 2C refrains from sending in a resource portion PC equal to one fifth of the bandwidth. The next upstream node 2B refrains from sending in a resource portion PB equal to two fifths of the bandwidth. The next upstream node 2A refrains from sending in a resource portion PA equal to three fifths of the bandwidth.

In this example, a portion of the bandwidth is preserved by the node concerned refraining from sending one or more packets of data when it has detected a gap having sufficient duration for at least one packet of data.

It must be noted here that the resource portion 3 for which sending is prohibited decreases on approaching the most downstream node. This implies that each node is certain to be able to preserve the necessary portion of the resource because it could preserve a subset of the portion already preserved by a more upstream node. Preserving gaps already preserved by an upstream node has the advantage of avoiding unnecessary preservation of additional gaps.

A service level agreement is associated with each client and therefore with each node. It is stored in the memory 7 of that node which contains, for example, statistical information defining a committed information rate (CIR) and a peak information rate (PIR). It supplies this information to the controller 11. This information is sent by each of the nodes 2A, . . . , 2D to the receiver means 6A of the bandwidth manager 13 to centralize the statistical information defining the requirements of the nodes 2A, . . . , 2D in respect of use of the resource 3.

There has been considered here quasistatic updating of information received by the receiver means 6A, but it is equally feasible to envisage dynamic updating of the information as a function of varying requirements, rather than as a function of a fixed agreement.

Each node 2A, . . . , 2D receives and stores in its memory 8 information concerning the requirements for use of the resource 3 by all the nodes on its downstream side. For example, the node 2B knows the requirements of the nodes 2C and 2D for use of the resource 3. The information contained in the memory 8 of the node 2B is converted in the logic circuit 9 into a signal representing a portion of the resource that is to be preserved. In this example, this signal represents a percentage of the total bandwidth of the resource 3 that is the sum of the respective percentages corresponding to the requirements of all the downstream nodes. In this example, preserving bandwidth consists in preserving certain gaps to allow all of the nodes on the downstream side of the node concerned to send packets of data in the preserved gaps.

The circuit 9 receives from the photodiode 10 a signal indicating whether the resource is free or not. If the resource is free, the circuit 9 measures the duration of the gap. The circuit 9 determines if the gap has a duration at least equal to the delay produced by the delay line 12. If so, knowing the percentage of the bandwidth that is to be preserved, the circuit 9 determines the duration of a prohibition signal to be sent to the circuit 5.

The circuit 5 receives a data packet sending request signal from the traffic admission controller 11 when the latter decides to send a packet. The circuit 5 transmits this data packet sending request signal to the buffer 4 if the circuit 9 authorizes it to send. If not, the circuit 5 waits for the circuit 9 to advise it of an unpreserved gap of sufficient duration for the length of the data packet to be sent.

In this example, the size of each packet having a payload may be 500 bytes or 1500 bytes. To allow sending of packets of maximum size, which here is 1500 bytes, the size of a gap preserved by a node refraining from sending must be at least equal to the maximum size of a data packet. In this example, each prohibition on sending by the circuit 9 has a duration corresponding to 1500 bytes or a multiple of 1500 bytes that is referred to herein as an elementary prohibition duration. The prohibition lasts until its duration reaches a total number of elementary prohibition durations corresponding to the percentage of the bandwidth to be preserved, the prohibition being predominant over the sending of packets. To preserve a resource portion corresponding to P data packets of the maximum size, the circuit 9 supplies to the circuit 5 a prohibition signal having a duration equal to P elementary prohibition durations. This results in a guaranteed bit rate or bandwidth for a plurality of nodes on the downstream side of the node concerned.

It is immaterial whether the logic circuits 5 and 9 are implemented in software or hardware.

In a preferred embodiment, the process is executed in accordance with the following algorithm:
If a node detects a gap and must refrain from sending for at least one elementary prohibition duration, i.e. 1500 bytes:
   If the gap has a size exceeding 1500 bytes, the node refrains from sending for at least one elementary prohibition duration (1500 bytes);
   If the gap has a size less than 1500 bytes and at least one data packet with a size of less than 1500 bytes is waiting in its buffer 4, then the node sends that packet.
If a node detects a gap, does not have to refrain from sending and has a data packet waiting in its buffer 4 of a size less than the size of the detected gap, then the node sends that packet.

Each node has the benefit of being able to use not only the portion of the bandwidth preserved by this preservation process but also the remaining bandwidth not used by nodes on its upstream side.

The controller 11 is a conventional simple queue that authorizes the sending of incoming packets with a transfer rate within limits fixed by an administrator. It consists in a buffer (called the token bucket) that is constantly filled with virtual information units produced at a specific bit rate. Each unit extracted from the bucket yields an authorization to send a data packet. This type of controller 11 assures a peak bit rate, i.e. that short bursts of data may be transmitted by extracting a series of accumulated units.

Because the circuit 5 collaborates with the controller 11, the operation of the circuit 5 depends on the class of service relevant to the node. Accordingly, a sending request generated by the controller 11 may be neutralized by a prohibition signal produced by the circuit 5: this is the case of the “best effort” classes. However, the circuit 5 may equally pend a sending request generated by the controller 11 in order to use it later: this is the case of “premium” classes.

The information contained in the memory 8 of this example is fixed information corresponding to a service level agreement, in which case the traffic monitoring method is a preventive method. It is equally feasible to envisage storing instead variable information updated by the downstream nodes, in order to alleviate congestion problems in the situation where a downstream node does not succeed in sending its packets and its buffers 4 are full. The traffic monitoring method is then based on the evolution of the network and is therefore a reactive process.

For certain applications, it may be advantageous also to provide means for synchronizing sending prohibitions in the various nodes of the network. This renders the resource access time deterministic. Circuit services may therefore be provided that necessitate not only a certain bandwidth but also knowledge of and a certainty as to the times that bandwidth is available.

Of course, the invention is not limited to the embodiment that has just been described. The invention has been described in the context of an optical network, but it is equally applicable to electronic networks. The resource described is a single wavelength and preserving a portion of the resource consisted in prohibiting a time slot on that wavelength alone, but the resource could be a set of wavelengths, each node using a variable number of wavelengths simultaneously, in which case the preservation of a portion of the resource would consist in each node refraining from using a certain number of wavelengths for a certain time.

1. Method of monitoring traffic in a network (1) comprising a plurality of nodes (2A, . . . , 2D) sharing one or more common resources (3) having a linear structure for sending data in a given direction, characterized in that it comprises in, in each node (2B):
detecting if said resource is being used to send data or if it is not being used;
then, if it is not being used, prohibiting the node (2B) concerned from sending data in a portion of said resource (3) that is determined statistically as a function of the requirements for use of said resource by all of the nodes (2C, 2D) on the downstream side of the node (2B) concerned.

2. Method according to claim 1, characterized in that, to determine a portion of said resource to be preserved by a statistical process and as a function of the requirements for use of that resource by all of the nodes (2C, 2D) on the downstream side of the node (2B) concerned, the method comprises in supplying to each of said nodes statistical information defining the resource requirements of all of the nodes on the downstream side.

3. Method according to claim 1, characterized in that, if said resource is not being used, it further comprises in measuring one or more lower limits of the time during which it is continuously unused and in that, to prohibit the node (2B) concerned from sending data in a portion of said resource (3), it further comprises in prohibiting the sending of data during a time interval having a duration equal to a predetermined elementary prohibition duration or a multiple thereof, the prohibition duration being made less than or equal to the measured duration.

4. Method according to claim 3, for a network transmitting data packets having variable sending durations, characterized in that the elementary prohibition duration is at least equal to the maximum duration for sending a packet and, in that case:
If a node detects that the resource is not being used and if the node must refrain from sending for one or more elementary prohibition durations:
If the duration of non-use is greater than an elementary prohibition duration, the node refrains from sending for at least one elementary prohibition duration;
If the duration of non-use is less than an elementary prohibition duration and there are one or more data packets having a size less than an elementary prohibition duration waiting in that node, the node sends said packet(s);
If a node detects that the resource is not being used, does not have to refrain from sending, and has a data packet waiting having a size less than the duration of non-use, the node sends that packet.

5. Method according to claim 2, characterized in that, to determine a portion of said resource to be preserved by a statistical process and as a function of requirements for use of said resource by all the nodes on the downstream side of the node concerned, the method comprises in supplying to the node concerned variable information updated by the downstream nodes in order to alleviate congestion problems if a downstream node does not manage to send its packets and its buffers are full.

6. Node for a network (1) comprising a plurality of nodes (2A, . . . , 2D) for sending data in a given direction that share one or more common resources (3) and have a linear structure, characterized in that it comprises:
means (10) for detecting if said resource is being used to send data or if it is not being used;
means (5, 9) for prohibiting the node concerned from sending data in a portion of said resource (3); and
means (8) for determining that resource portion as a function of requirements for use of said resource by all the nodes (2C, 2D) on the downstream side of the node (2B) concerned.

7. Node according to claim 6, characterized in that the means (8) for determining said resource portion include means (8) for receiving and storing statistical information defining the resource requirements for all the nodes on the downstream side.

8. Node according to claim 6, characterized in that the means (10) for detecting if said resource is being used to send data or if it is not being used include means for measuring one or more lower limit(s) of the time during which it is continuously not being used
and in that the means (5, 9) for prohibiting the node (2B) concerned from sending data in a portion of said resource (3) include means for prohibiting the sending of data during a time interval having a duration equal to a predetermined elementary prohibition duration or a multiple thereof, the prohibition duration being less than or equal to the measured duration.

9. Node according to claim 6, characterized in that it further includes synchronization means for synchronizing prohibition of sending by the various nodes of said network.

10. Network (1) characterized in that it includes a plurality of nodes (2A, 2B, 2C, 2D) according to claim 1.

11. Network according to claim 10, characterized in that it further includes:
means (6A) for receiving information on the requirement for use of said resource by all the nodes, and
means (6B) for sending each of said nodes information on the requirement for use of said resource by the nodes on the downstream side of the node concerned.
